(19) United States
(12) Patent Application Publication
(10) Pub. No.: US 2004/0243921 A1
(43) Pub. Date: Dec. 2, 2004

(54) Methods and systems for synchronizing document elements

(76) Inventors: Steven Paul Carr, Edmonton (CA); David Michael Robertson, Edmonton (CA); Pete William Sage, Stephentown, NY (US); Sunil Mathur, Rexford, NY (US); Wes Arthur Tutak, Edmonton (CA); Russell Fredrick Charchuk, Edmonton (CA); Daniel James Hanson, Edmonton (CA)

Correspondence Address: John S. Beulick, Armstrong Teasdale LLP, Suite 2600, One Metropolitan Sq., St. Louis, MO, 63102, US

(21) Appl. No.: 10/449,198

(22) Filed: May 30, 2003

(51) Int. Cl. G06F 17/00

(52) U.S. Cl. 715/500; 715/530

(57) ABSTRACT

A method for linking Document Object Model (DOM) elements using link attributes is provided. The method includes maintaining a plurality of DOM documents, linking at least one element in a first DOM document to at least one element in a second DOM document, revising an element in the first DOM document, and synchronizing the linked element in the second DOM document with the revised element in the first DOM document.

### BACKGROUND OF THE INVENTION

This invention relates generally to automation control systems, and more specifically to methods and apparatus for synchronizing document elements in a network system.

At least some known network-based data systems maintain a plurality of documents that include similar data from disparate documents in one or more other documents. The data is fetched manually by directly querying the various data sources. The data is then combined into an XML document that is transformed with an XSL parser. Once the static data has been normalized, it is finally ready for use. However, maintaining the data in a current state in all documents may require periodically polling data sources, fetching new data, and continuing the process repetitively.

However, such a system may not keep the data sufficiently current in all needed documents and/or may require significant resources to maintain the data current. Moreover, maintaining data currency up to real-time standards and making data updates bi-directional in such a system may utilize significant system resources and/or limit the system performance.

### BRIEF DESCRIPTION OF THE INVENTION

In one aspect, a method for linking Document Object Model (DOM) elements using link attributes is provided. The method includes maintaining a plurality of DOM documents, linking at least one element in a first DOM document to at least one element in a second DOM document, revising an element in the first DOM document, and synchronizing the linked element in the second DOM document with the revised element in the first DOM document.

In another aspect, an automation control system is provided. The system includes a plurality of DOM documents residing on at least one module, and at least one element in a first DOM document linked to at least one element in a second DOM document wherein revising said element in the first DOM document synchronizes said linked element in the second DOM document with the revised element in the first DOM document.

### BRIEF DESCRIPTION OF THE DRAWINGS

FIG. 1 is a block diagram illustrating one embodiment of an automation control module (ACM) system;

FIG. 2 is a data flow diagram for a plurality of exemplary DOM documents that may be used in the system shown in FIG. 1;

FIG. 3 is a data flow diagram of an exemplary Glink translation that may be used in the system shown in FIG. 1;

FIG. 4 is a data flow diagram of an exemplary Glink transformation that may be used in the system shown in FIG. 1;

FIG. 5 is a data flow diagram of an exemplary Glink substitution that may be used with the system shown in FIG. 1; and

FIG. 6 is a flowchart of an exemplary method 600 of implementing a GLink.

### DETAILED DESCRIPTION OF THE INVENTION

A GLink is a real-time, bi-directional link between XML documents that allows for transparent exchange and normalization of data gathered from many different data sources and live systems. Client applications that are backed by these real-time normalized documents may focus on the value added features of the information rather than collecting and managing the data. Specifically, a GLink is a link between DOM elements. The two elements that are linked remain synchronized based on various GLink attributes.

A GLink is an extension to the Document Object Model (DOM). A user uses XML attributes to define the link either with specific values, or with a substitution expression, which is then resolved by the GLink extension. Once resolved, DOM Mutations are used and may be translated and/or transformed to keep the two elements synchronized.

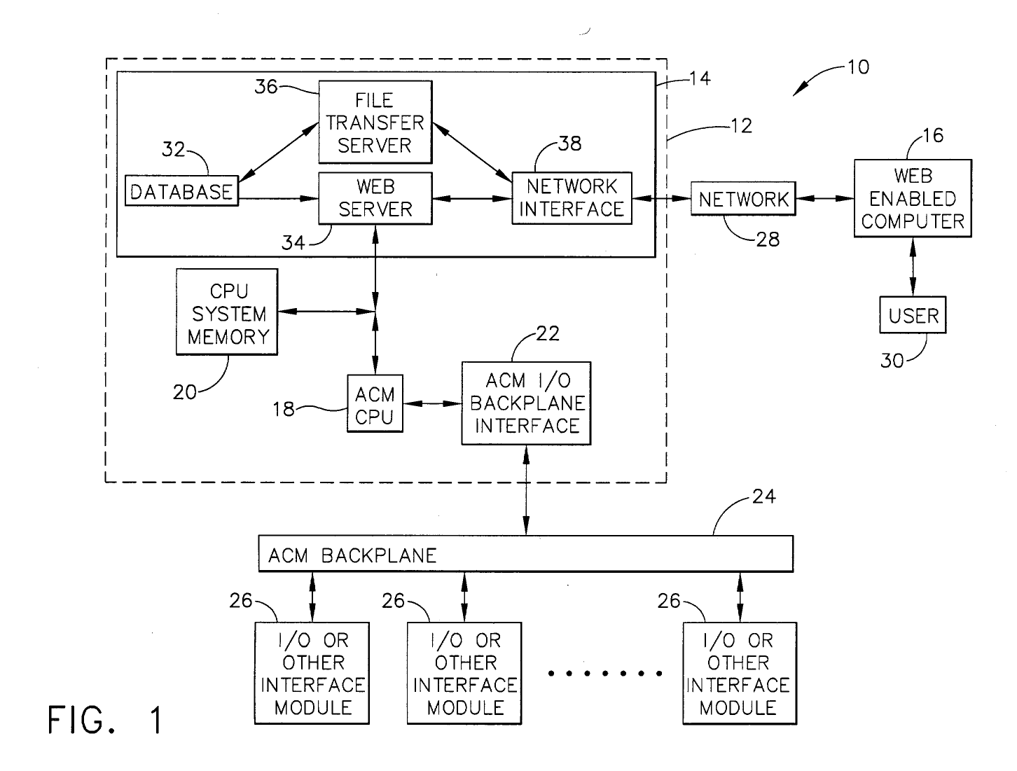

FIG. 1 is a block diagram illustrating one embodiment of an automation control module (ACM) system 10. System 10 includes an eWeb ACM 12, a web and file transfer subsystem 14, and a web-enabled computer 16. EWeb ACM 12 includes an ACM CPU 18 that carries out ACM functions, for example user logic and function block executions, input/output (I/O) scanning, and communications to other devices. ACM CPU 18 includes a CPU system memory 20 electrically connected to CPU 18 and, in one embodiment, contains both the operating system (not shown) for ACM CPU 18 and a user's program and data. In one embodiment, an ACM I/O backplane interface 22 is connected to ACM CPU 18, and provides an interface between ACM CPU 18 and an ACM backplane 24 connected to interface 22. ACM backplane 24 provides a physical and electrical means for connecting various I/O or other input modules 26, for example communications or motion modules, into eWeb ACM 12. ACM backplane 24 facilitates the exchange of data between modules 26 and ACM CPU 18. In one embodiment, one or more modules 26 provide an interface for real world inputs (not shown), such as limit or proximity switch status, position of an object, temperature, or pressure, to ACM CPU 18 as parameters for logic or function block execution. In another embodiment, one or more modules 26 provide an interface to real world outputs (not shown) as commanded by ACM CPU 18 to control output devices (not shown), such as actuators, contactors, or solenoids.

Web-enabled computer 16 is electrically connected to a network 28. Network 28 includes the physical medium and intermediate devices (not shown), such as routers, and switches, that connect computer 16 to eWeb ACM 12. In one embodiment, network 28 is a wide area network (WAN), such as the Internet. In an alternative embodiment, network 28 is a local area network (LAN), such as an Intranet. In yet another alternative embodiment, network 28 uses Ethernet standard. A user 30 accesses, such as dialing into, or directly logging onto, an Intranet or the Internet to gain access to eWeb ACM 12. In one embodiment, computer 16 includes a web browser, and eWeb ACM 12 is accessible to computer 16 via the Internet. Computer 16 is interconnected to the Internet through many interfaces including a different network (not shown), such as a WAN or a LAN, dial in connections, cable modems and special high-speed ISDN lines. Computer 16 is any device capable of interconnecting to the Internet, including a web-based telephone or other web-based connectable equipment.

Computer 16 displays PLC data on at least one web page (not shown), and retrieves web page files (not shown) stored on a database 32 embedded within web and file transfer subsystem 14. Web page files are text files that may contain hypertext markup language (HTML), Javascript, and/or references to other files, such as image files to be displayed with the web page or Java Applets. In another embodiment, web page files include ACM tag functions that reference ACM data stored in CPU system memory 20. The tag facilitates the exchange of data between ACM CPU 18 and a web server 34 embedded within web and file transfer subsystem 14. Further, the tag provides a generic mechanism for user 30 to display and/or control ACM data with a standard browser. In one embodiment, computer 16 includes web authoring tools and/or text editors that, along with user input, are utilized to create and modify web page files.

User 30 views and/or controls ACM data from computer 16. In one embodiment, user 30 created a web page file. Web and file transfer subsystem 14 is electrically connected to ACM CPU 18, CPU system memory 20, and network 28. Subsystem 14 is shown in FIG. 1 to be embedded within eWeb ACM 12. In an alternative embodiment, subsystem 14 is contained in a separate module connected to backplane 24. Web and file transfer subsystem 14 includes database 32, web server 34, a file transfer server 36, and a network interface 38 that provides the lower level protocols (TCP/IP) and physical hardware connections to network 28. File transfer server 36 is electrically connected to database 32 and network interface 38, and transfers web page files and associated elements between database 32 and computer 16. File transfer server 36 facilitates downloading customizable user defined web pages to eWeb ACM 12 as described below. In one embodiment, file transfer server 36 is a file transfer protocol server.

Web servers 34 is electrically connected to database 32, network interface 38, and ACM CPU 18. Web server 34 receives and processes hypertext transfer protocol (HTTP) requests to send web pages to computer 16 and, based upon the requests, sends the requested web page to computer 16. If the requested web page includes a tag function, web server 34 parses and executes the tag function and either embeds ACM data within a web page file thereby displaying the web page on a browser on computer 16, or transmits ACM data to ACM CPU 18. In one embodiment, web server 34 transfers ACM data to ACM CPU 18 to control operation of eWeb ACM 12.

In one embodiment, user 30 must enter a valid user name and valid user password to access eWeb ACM 12 and web and file transfer subsystem 14. The user name and user password correspond to a user profile stored in database 32. User 30 configures the number of web and file transfer TCP connections (not shown) using computer 16. A value of zero allows user 30 to disable the web and file transfer TCP connections.

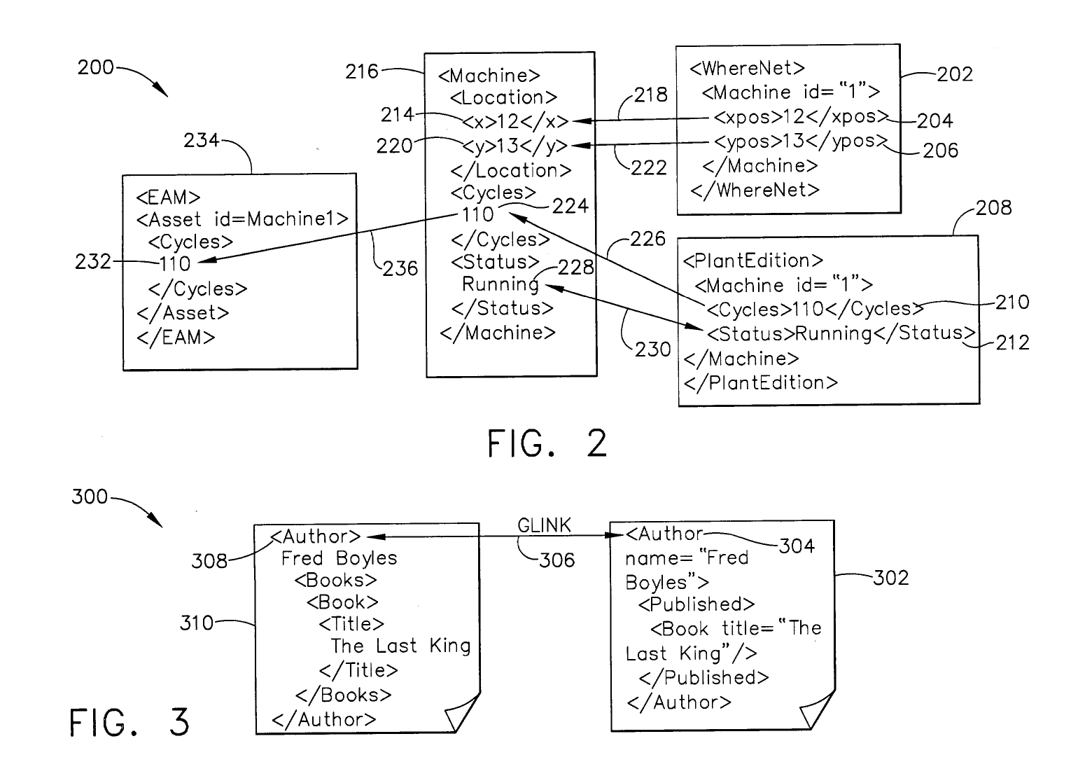

FIG. 2 is a data flow diagram 200 for a plurality of exemplary DOM documents that may be used in system 10 shown in FIG. 1. It may be desired to combine and view enterprise data from a number of sources in a single document. For example, each data source may be represented by one XML document. One known method of providing access to multiple data sources is to have the client applications query for all of these XML documents manually. That is, the client application would manage multiple XML documents of raw data, and would be responsible for polling each document, validating data, and making such data available to each client. In the exemplary embodiment, all the required data is automatically normalized into one concise document using a GLink.

A GLink definition describes a synchronization link between two elements in different DOM documents. Once a GLink is established, mutations or changes made to one element are reflected in the other. In this way, one document can contain data from multiple sources.

System 10 may include a first document 202 that includes data from a plurality of machine position sensors (not shown) that input data to an “xpos” document element 204 and a “ypos” document element 206. A second document 208 may receive data from other machine sensors (not shown) that input data into a “cycles” document element 210 and a “status” element 212. In the exemplary embodiment, element 204 is linked to an “x” element 214 in a third document 216 through a read-only Glink 218. Similarly, element 206 is read-only linked to a “y” element 220 in document 216 through read-only-link 222. Element 210 is linked to a “cycles” element 224 in document 216 through a read-only link 226. “Status” element 212 is linked to a “status” element 228 of document 216 through a bidirectional link 230.

A type of GLink may be setup in which mutations flow in only one direction, termed a read-only Glink. For read-only GLinks, a change in the provider element, such as, for example elements 204, 206, and 210 will be synchronized with each respective subscriber elements 214, 220, and 224, but not vice versa. If any of the subscriber elements are modified, the mutation is not sent to the provider element.

A bi-directional Glink, such as, for example, link 230 synchronizes linked elements without regard to which element was changed. In the exemplary embodiment, a change to element 228 causes a mutation to be fired to element 212. The mutation includes information that is used by link 230 to revise element 212 to match element 228. Similarly, a change to element 212 causes a mutation to be fired to element 228. The mutation includes information that is used by link 230 to revise element 228 to match element 212.

An element may be a subscriber and provider simultaneously. For example, element 224 of document 216 is also linked to a cycles element 232 in a third document through a read-only link 236. A change to element 210 fires a mutation through link 226 to element 224. The change to element 224 caused by the receipt and processing of the mutation causes a subsequent mutation to be fired to element 232 through link 236. Since element 232, as illustrated has no subscribers, a further mutation is not generated, and all three elements 210, 224, and 232 are synchronized to the same value. In a second example, a change to element 224 fires a mutation to element 232 causing elements 224 and 232 to be synchronized, but because link 226 is a read-only link wherein element 224 is a subscriber of provider element 210, element 224 does not fire a mutation to element 210, consequently element 210 is not changed to be synchronized with elements 224 and 232. Such a methodology allows overriding an upstream document, if desired by a user.

A GLink is setup by using the GLink attributes. GLink attributes are XML attributes belonging in the GLink namespace. The basic GLink attributes are UUID and PATH. The UUID attribute uniquely identifies the document from all other documents existing on system 10, and the PATH is a xpath expression identifying the element inside of the document to link with. The element that contains the GLink attributes is the subscriber element. An element can only subscribe to one other element. The other element (the element that does not contain the GLink attributes) is the provider element. An element can be a provider for any number of GLinks.

A bi-directional GLink may synchronize all changes made on either element. That is, all attribute changes, and all children changes are synchronized. These changes are also synchronized as is. For example, if an attribute called “HelloWorld” were added to one element, the other element would be synchronized with an identical “HelloWorld” attribute.

A GLink is an extension to the Document Object Model (DOM). A user uses XML attributes to define the link, which is then resolved by the GLink extension. Once resolved, DOM mutations are used (and sometimes translated and/or transformed) to keep the two elements synchronized.

FIG. 3 is a data flow diagram 300 of an exemplary Glink translation that may be used in system 10 (shown in FIG. 1). In alternative embodiments, complete synchronization between documents may not be desirable. Therefore, elements that are to be synchronized may be further defined as to what is synchronized and how data should look in the element that is receiving the changes.

In the exemplary embodiment, a first document 302 includes an “Author” element 304 that is bi-directionally linked through a GLink 306 to an “Author” element 308 in a second document 310. When a mutation occurs in document 310, it is translated before being applied to document 302 such that only the XML structure of element 304 is changed. GLink translation allows for modification of the XML structure, not the actual values of attributes or text items.

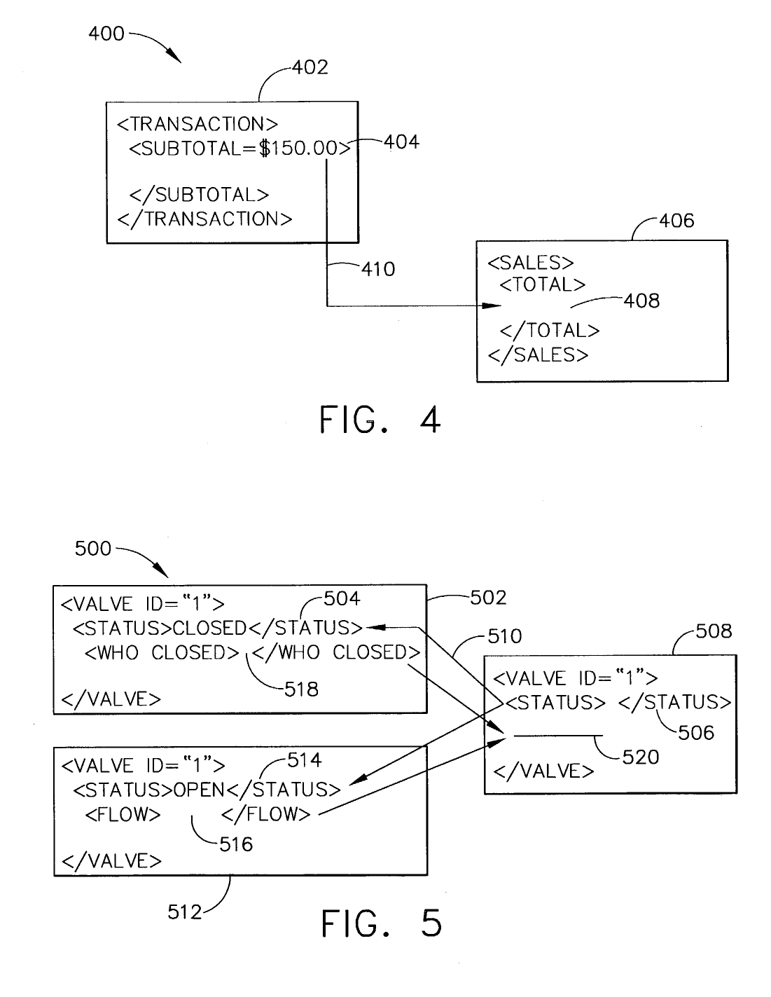

FIG. 4 is a data flow diagram 400 of an exemplary Glink transformation that may be used in system 10 (shown in FIG. 1). It may be desirable to “transform” a value in one document before applying the value in another document. A GLink transformation permits changing attribute values and text items from one document before applying them to a second document. For example, a document may contain an attribute value of “$150” representing the price of an article for sale. A normalized document may need to account for sales tax on that same article. A GLink transformation may be applied to that attribute value before it is sent to the other normalized document. In the exemplary embodiment, a first document includes a “subtotal” element 402 that may be linked to a second document 406 that includes a “total” element 408 linked through a link 410. A mutation from the “subtotal” provider element 404 will be transformed (a sales tax will be added) before being applied to element 408. Element 408 would then contain the total value.

FIG. 5 is a data flow diagram 500 of an exemplary Glink substitution that may be used with system 10 (shown in FIG. 1). It may be desirable to change a value of a linked element selectively based upon an output, outcome, and/or other data. In such a case, a Glink may be set-up dynamically, that is, the value of the UUID and PATH may be unknown until some event occurs. For example, depending on a particular state, a GLink may point to different elements. In the exemplary embodiment, a first document 502 includes a “status” element 504 that is a subscriber to a “status” element 506 in a second document 508 through a link 510. A third document 512 includes a “status” element 514 that is also a subscriber of element 506. A “flow” element 516 may indicate a magnitude of fluid flow through the valve. The value of flow through the valve would only be of interest when the valve was opened. In a closed state of the valve, an indication of who closed the vale may be of interest. A “whoclosed” element 518 of document 502 may hold that information. Element 506 represents the valve position of a valve (not shown) wherein the state of the valve is either opened or closed. If the valve is in an opened state, the normalized view of the document may include other details such as the current flow through the valve. In this case, a GLink may be established to document 514 that includes element 516 that contains valve flow information. When the valve is in a closed state, the normalized view of document 508 may include details on who closed it, which may be included in document 502 in element 518. In such cases, GLink substitution is used to establish the link depending of the state of element 506 to return a value to an element 520 in document 508 that is either a value of flow passing through the open valve or an indication of who closed the valve. GLink attributes may be built up based on values in other parts of the document, or with values passed in from the application.

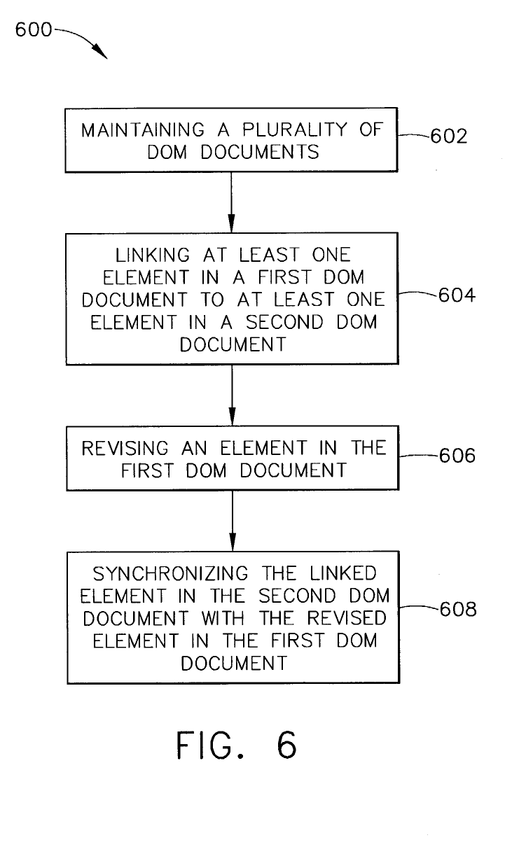

FIG. 6 is a flowchart of an exemplary method 600 of implementing a GLink. Method 600 includes maintaining 602 a plurality of DOM documents. The documents may be maintaining on an enterprise network system and may include documents maintaining by various corporate entities, including customers and vendors. The documents may also reside in a dedicated system such as an automation control system in an industrial or commercial establishment. Information maintained in a plurality of documents may be needed by other documents to provide real-time normalized data for computation and/or display. As used herein, real-time refers to outcomes occurring at a substantially short period after a change in the inputs affecting the outcome, for example, computational calculations and/or element linking. The period may be an amount of time between each iteration of a regularly repeated task. Such repeated tasks are called periodic tasks. The time period is a design parameter of the real-time system that may be selected based on the importance of the outcome and/or the capability of the system implementing processing of the inputs to generate the outcome. Additionally, events occurring in real-time occur without substantial intentional delay. In the exemplary embodiment, links are updated and mutations are fired in real-time within network and component capabilities.

System 600 documents may be linked 604 between at least one element in a first DOM document to at least one element in a second DOM document. Linking permits information to pass between documents quickly with little overhead costs automatically such that application programs that rely on current data in documents do not have to utilize their resources to maintain data currency. The DOM architecture and XML programming maintains the data currency. Revising 606 an element in the first DOM document may cause the element to fire a mutation to all subscriber elements such that all subscriber elements are synchronized 608 with the revised element in the first DOM document.

Although a particular element can only specify one GLink such that a particular element can only be a subscriber for one GLink, it is possible for a GLink to be a provider for multiple GLinks. In this way, two or more elements can be linked together. For example, X can be linked to Y, and Y linked to Z. If a change occurs in X, the mutation will be sent to Y, and finally to Z. A race condition can occur if two elements change substantially simultaneously. For example, if X and Z changed at the same time, there would be a race to Y. The race may be dependent on the hardware and/or network capabilities and latencies. GLink does not guarantee the order in which mutations from two different sources get applied. However, when the race is finished, X, Y and Z will be fully synchronized with the last change to reach Y.

When two or more elements are linked together, it is possible for a circular GLink to occur. For example, X can be linked to Y, Y linked to Z, and Z linked back to X. A mutation from X would be sent to Y, then to Z. Z would then send the mutation back to X, who would then send it to Y, then to Z etc. To avoid this circular GLink behavior, mutations include data that indicates elements that have already applied that mutation. As such, Z would not send the mutation back to X, as it would know that the mutation had already been at X.

The above-described document linking method is cost-effective and highly reliable for linking elements in disparate documents to normalize and synchronize data between the documents. Specifically, the document linking method facilitates combining useful data from multiple DOM documents into one DOM document, transforming XML data and DOM mutation events, and synchronizing data in real-time such that it remains live and up to date. As a result, the methods and apparatus described herein facilitate reducing application program overhead and managing data in a cost-effective and reliable manner.

While the invention has been described in terms of various specific embodiments, those skilled in the art will recognize that the invention can be practiced with modification within the spirit and scope of the claims.

What is claimed is:

1. A method of linking Document Object Model (DOM) elements using link attributes, said method comprising:
maintaining a plurality of DOM documents;
linking at least one element in a first DOM document to at least one element in a second DOM document;
revising an element in the first DOM document; and
synchronizing the linked element in the second DOM document with the revised element in the first DOM document.

2. A method in accordance with claim 1 wherein maintaining a plurality of DOM documents comprises maintaining a plurality of DOM documents in an enterprise network environment.

3. A method in accordance with claim 1 wherein maintaining a plurality of DOM documents comprises maintaining a plurality of DOM documents in an Internet environment.

4. A method in accordance with claim 1 wherein maintaining a plurality of DOM documents comprises maintaining a plurality of DOM documents in an automation control system.

5. A method in accordance with claim 1 wherein linking at least one element in a first DOM document comprises bi-directionally linking at least one element in a first DOM document.

6. A method in accordance with claim 1 wherein linking at least one element in a first DOM document comprises linking at least one element in a first DOM document as a read-only link.

7. A method in accordance with claim 1 wherein the DOM document includes tags having attributes, and wherein linking at least one element in a first DOM document comprises establishing a link between the first DOM document and the second DOM document.

8. A method in accordance with claim 7 wherein establishing a link between the first DOM document and the second DOM document comprises establishing a link between the first DOM document and the second DOM document using DOM attributes.

9. A method in accordance with claim 8 wherein establishing a link between the first DOM document and the second DOM document using DOM attributes comprises establishing a link between the first DOM document and the second DOM document using DOM attributes in a subscriber element.

10. A method in accordance with claim 8 wherein establishing a link between the first DOM document and the second DOM document using DOM attributes comprises establishing a link between the first DOM document and the second DOM document using DOM attributes that include at least one of a DOM document object, a DOM data source, and an expression that identifies the linked element.

11. A method in accordance with claim 7 wherein establishing a link between the first DOM document and the second DOM document comprises establishing a link between the first DOM document and the second DOM document dynamically.

12. A method in accordance with claim 11 wherein establishing a link between the first DOM document and the second DOM document comprises establishing a link between the first DOM document and the second DOM document dynamically based on a state of an element.

13. A method in accordance with claim 1 wherein revising an element in the first DOM document comprises revising an element in the first DOM document through a user interaction.

14. A method in accordance with claim 1 wherein revising an element in the first DOM document comprises revising an element in the first DOM document through a DOM event.

15. A method in accordance with claim 1 wherein revising an element in the first DOM document comprises firing a mutation event to the second DOM document.

16. A method in accordance with claim 15 wherein firing a mutation event to the second DOM document comprises:
determining if the mutation has been applied to the second DOM document.

17. A method in accordance with claim 1 wherein synchronizing the linked element in the second DOM document comprises:
receiving a fired mutation event;
authenticating at least one of a mutation event sender, a mutation event previous value, and a mutation event new value; and
firing a mutation event to linked child documents.

18. A method in accordance with claim 1 further comprising:
revising an element in the second DOM document;
firing a mutation event to a linked element in the first DOM document if the link is bi-directional.

19. A method in accordance with claim 17 further comprising:
translating a mutation such that an XML structure of the mutation is changed; and
applying the translated mutation to the second document.

20. A method in accordance with claim 17 further comprising:
transforming a mutation such that at least one of a value of an attribute and a text item of the mutation is changed; and
applying the transformed mutation to the second document.

21. A method of linking Document Object Model (DOM) elements using link attributes in an XML based automation control system, said method comprising:
maintaining a plurality of DOM documents in an automation control system;
linking at least one element in a first DOM document to at least one element in a second DOM document;
revising an element in the first DOM document; and
synchronizing the linked element in the second DOM document with the revised element in the first DOM document.

22. A method in accordance with claim 21 wherein linking at least one element in a first DOM document comprises bi-directionally linking at least one element in a first DOM document.

23. A method in accordance with claim 21 wherein linking at least one element in a first DOM document comprises linking at least one element in a first DOM document as a read-only link.

24. A method in accordance with claim 21 wherein linking at least one element in a first DOM document comprises establishing a link between the first DOM document and the second DOM document using DOM attributes.

25. A method in accordance with claim 24 wherein establishing a link between the first DOM document and the second DOM document using DOM attributes comprises establishing a link between the first DOM document and the second DOM document using DOM attributes that include at least one of a DOM document object, a DOM data source, and an expression that identifies the linked element.

26. A method in accordance with claim 24 wherein establishing a link between the first DOM document and the second DOM document comprises establishing a link between the first DOM document and the second DOM document dynamically.

27. A method in accordance with claim 21 wherein revising an element in the first DOM document comprises firing a mutation event to the second DOM document.

28. A method in accordance with claim 27 wherein firing a mutation event to the second DOM document comprises:
determining if the mutation has been applied to the second DOM document.

29. A method in accordance with claim 27 wherein synchronizing the linked element in the second DOM document comprises:
receiving a fired mutation event;
authenticating at least one of a mutation event sender, a mutation event previous value, and a mutation event new value; and
firing a mutation event to linked child documents.

30. An automation control system comprising:
a plurality of DOM documents residing on at least one module; and
at least one element in a first DOM document linked to at least one element in a second DOM document wherein revising said element in the first DOM document synchronizes said linked element in the second DOM document with the revised element in the first DOM document.

31. A system in accordance with claim 30 wherein said at least one element in a first DOM document is bi-directionally linked to at least one element in a second DOM document.

32. A system in accordance with claim 30 wherein said at least one element in a first DOM document is read-only linked to at least one element in a second DOM document.

33. A system in accordance with claim 30 wherein said at least one element includes a DOM attribute, said link established using DOM attributes.

34. A system in accordance with claim 33 wherein said DOM attributes include at least one of a DOM document object, a DOM data source, and an expression that identifies the linked element.
